(19) United States
(12) Patent Application Publication
(10) Pub. No.: US 2012/0268231 A1
(43) Pub. Date: Oct. 25, 2012

(54) Hot/cold forming and assembling magnetic component

(76) Inventor: S. R. Shang, Keelung (TW)

(21) Appl. No.: 13/089,490

(22) Filed: Apr. 19, 2011

(51) Int. Cl. H01F 17/04

(52) U.S. Cl. 336/221

(57) ABSTRACT

The technology of this invention is to combine the advantage of cold and hot forming magnetic component. Use the advantage of hot forming technology which is 3D complex forming, and use hot-forming magnetic powder to form magnetic component body. Single or multiple rod spaces including T shape, “I” shape or rod shape are previously reserved, and advantage of cold forming technology is used to produce core rod in the highest density of magnetic line, in order to provide the source of high induction magnetic line. Next, assemble single or multiple core rods with body, in order to obtain assembling magnetic component of final desiring magnetic induction.

### BACKGROUND OF THE INVENTION

1. Technical Field

The invention relates to an assembling magnetic component which combines the advantage of cold and hot forming magnetic component, and assembles cold forming high-density core rod in hot forming magnetic component body, in order to obtain the final high magnetic induction.

2. Description of Related Art

Concerning the magnetic inductor component which is used in market condition, the basic structure is the current-carrying coil which is set at the periphery of the core rod, and magnetic shield material is packaged at the periphery of core rod and current-carrying coil. A general production method is divided into cold and hot forming method. A cold forming method is to form a core rod and magnetic shield material by cold forming method first, and then assemble with current-carrying coil to form a cold forming magnetic component. A hot forming method is to form core rod and magnetic shield material by hot forming method, and then assemble with current-carrying coil to form a hot forming magnetic component.

As we know, obvious property differences exist in the magnetic component produced by hot and cold forming technology. Hot forming technology is to inject softened/liquefied powder into mold for hot forming, and the advantages are being consistent with complex design shape requirement, high mechanical strength, and low magnetic line loss. Besides, cold forming technology is to force the powder to cold form by pressing, and the advantages are high magnetic material weight rate and lower production cost. Therefore, when producing magnetic component with single hot forming or cold forming method, reverse disadvantages other than the advantage exist.

According to the disadvantage of traditional hot forming or cold forming magnetic component, hot/cold forming and assembling magnetic component is investigated and developed in this study. It combines the advantage of cold and hot forming magnetic component, and obtains the assembling magnetic component with final desiring magnetic induction.

### BRIEF SUMMARY OF THE INVENTION

Before describing the technology content of this invention, please allow us to define or explain the material or technology applied in this invention as follow:
Core rod: The magnetic inductive material surrounded by coil in general magnetic component, which can be single individual or with components according to requirements, and there are different shape variations, such as T type and rod type.
Magnetic powder: As for magnetic powder mentioned in this invention, the possible material includes Iron, Iron-Silicon (Fe—Si), Ferrite, Sendust or other magnetic material, such as Hi-Flux, MPP (Molypermalloy Powder) and Amorphous, or aforementioned composite material.
Hot-forming magnetic powder: The hot-forming magnetic powder mentioned in this invention is the aforementioned magnetic powder with heated liquid plastic material, such as PC, PS, PE, Nylon, and PP. Please refer to the content of U.S. patent pending application Ser. No. 12/559,580 for technical detail.
Coil: Coil mentioned in this invention is copper wire with insulation surface, which becomes coils in singles or multiple turns, in order to carry current and generate an external magnetic field.
Assembly: Assembly mentioned in this invention is to reserve holes, tenon, and location design for assembly of each component previously, and combine by mechanical or manual means. Common glue sold in market condition can be used for adhesion between each component, such as epoxy resin, silica gel, and instant glue.
Hot forming technology: Mainly heat heat-forming magnetic powder to soften and melt during heat and pressure process. Powder flows to mold and forms, which can form 3D complex forms, such as corner, hollow, and small size. The product doesn't require annealing and the size is precise, but the disadvantage is high production cost.
Cold forming technology: Press the powder to form. Mechanical pressure is mainly used to form, and then the product is completed by annealing and sintering. The advantage is low production cost, but the disadvantages are the product requires annealing, size varies more, and 3D complex forming cannot be performed.

The differences between the technology characteristics of this invention and technology of general cold or hot forming assembling magnetic component are listed and analyzed as follow:

| | | | |
|---|---|---|---|
| Name | (This invention) | Traditional cold | Traditional hot |
| | Hot/cold forming | forming | forming |
| | assembling | assembling | assembling |
| | magnetic | magnetic | magnetic |
| | component | component | component |
| Illustration | After the hot forming of | Each component | Each component |
| | coil and hot-forming | is formed by cold | is formed by hot |
| | magnetic powder, | forming method, | forming method, |
| | cold-forming | and then coil is | and then coil is |
| | production magnetic | assembled to | assembled to |
| | core is assembled and | form a magnetic | form a magnetic |
| | combined to form a | component. | component. |
| | magnetic component. | | |
| Multiple | Yes | Yes | Yes |
| material | | | |
| assembling | | | |
| Magnetic | High | High | Lowest |
| material | | | |
| weight rate | | | |
| Forming | Low | High | Lowest |
| pressure | | | |
| Assembling gap | Low | Highest | Low |
| Loss of gap | Low | Highest | Low |
| magnetic | | | |
| line | | | |
| Saturation gap design* | Yes | Yes | Yes |
| External | High | Low | High |
| strength | | | |
| Production | Medium | Low | High |
| cost | | | |
| Reference | The content of this | http://www.magict | |
| | invention | ec.com.tw/product | |
| | | s.html APL series | |
| | | induction, Magic | |
| | | Technology | |

*General magnetic component generates air gap in magnetic field line, which delays magnetic saturation.

From the above comparative analysis, this invention combines hot forming technology of which the advantages are complicated design, high mechanical strength and low magnetic line loss with cold forming technology of which the advantages are high magnetic material weight rate and lower production cost, and creates several assembling form of body and core rod, which can be applied to new magnetic component development, in order to obtain assembling magnetic component of final desiring magnetic induction.

### DETAILED DESCRIPTION OF THE INVENTION

As demonstrated from FIG. 1 to 6 of this invention, hot/cold forming assembling magnetic component in this invention is mainly composed of four parts, including rod shape core rod 1, current-carrying coil 2, a pair of lead pads 3 and hot forming body 4.

The rod shape core rod 1 is composed of magnetic powder, which is generated and formed by cold forming technology, and mainly provides the induction magnetic line source of magnetic component. It is loaded in rod space 41 of hot forming body 4. There are also variations in rod shape core rod 1, such as rod shape core rod including single body 1, T shape core rod 1A, and rod shape core rod 1 and T shape core rod 1A which are composed of multiple core rod components.

As for current-carrying coil 2, the coil is generated by insulated copper wire with functions of current carrying and external magnetic field generation.

A pair of lead pads 3 are mainly generated by conductive copper pads. One end of each lead pad connects to one end electricity of current-carrying coil 2, and another end extends out of hot forming body 4 as current input and out put electrodes.

Hot forming body 4 is composed of hot-forming magnetic powder and generated by hot forming technology. Magnetic powder coats current-carrying coil 2 and part of lead pad 3, and rod space 41 for rod shape core rod 1 loading is reserved. Rod space 41 can also be T shape rod space 41A.

As demonstrated in FIGS. 3 and 6, rod shape core rod 1 or T shape core rod 1A is added with glue and loaded in rod space 41 or T shape rod space 41A of hot forming body 4 in this invention, in order to assemble hot/cold forming assembling magnetic component of this invention.

After current passes through two ends of lead pad 3, external magnetic field will be generated in current-carrying coil 2, and then a magnetic field M will be generated in core rod 1 (as demonstrated in the dotted line region of the figure), in order to become the electromagnetic component with energy storage function.

Rod shape core rod 1 of this invention can be divided into independent single body or combination of multiple components:

A. Independent single body: The material is totally the same, which is generated by single magnetic powder through cold forming technology, as demonstrated in FIGS. 2 and 4. The main application shapes in this invention are rod shape core rod 1 and T shape core rod 1A. The advantages are simple production, and rapid mass production. Besides, the above two single bodies can combine with other or the same single body.
B. Multiple components: Final T shape core rod 1A is assembled by using multiple components. The same or different magnetic powder can be used in each component, which is generated by cold forming technology. The advantage is to combine different magnetic powders according to magnetic component requirement, as demonstrated from FIG. 7 to 9, which include
1. Combine disk shape core rod 11 with rod shape core rod to form T shape core rod 1A.
2. Combine groove disk shape core rod 13 of groove 131 with rod shape core rod 12 to form T shape core rod 1A.
3. Combine perforated disk shape core rod 14 of hole 141 with rod shape core rod 12 to form T shape core rod 1A. As for rod shape core rod 12, the length can be adjusted to be out of the surface of perforated disk shape core rod 14 according to requirements.

Hot forming body 4 of this invention includes:
A. As demonstrated in FIG. 10, hot forming body 4 formed by hot-forming magnetic powder through hot forming forms bowl structure which coats exterior and bottom of current-carrying coil 2 and interior of current-carrying coil, top, and coil center are exposed to form T shape rod space 41A right above the center of current-carrying coil 2.
B. As demonstrated in FIG. 11, hot forming body 4 formed by hot-forming magnetic powder changes into bowl structure to coat the external side and bottom of current-carrying coil 2, and interior of current-carrying coil and top of the coil are exposed. Besides, the side right below the center of current-carrying coil is not coated, and T shape rod space is formed 41A.
C. As demonstrated in FIG. 12, hot forming body 4 formed by hot-forming magnetic powder changes into bowl structure to coat the external side and bottom of current-carrying coil 2, and interior of current-carrying coil 2 is exposed. Besides, the side right above the center of current-carrying coil 2 and the side right below the center of coil are not coated, and rod shape rod space is formed 41.
D. As demonstrated in FIG. 13, hot forming body 4 formed by hot-forming magnetic powder changes into bowl structure to coat the external side of current-carrying coil 2 only. Interior, top, and bottom of current-carrying coil 2 are exposed to form “I” shape rod space which is composed of two T shape rod spaces.
E. As demonstrated in FIG. 14, hot forming body 4 formed by hot-forming magnetic powder changes into derivative shape, the difference in shape with hot forming body 4 in FIG. 10 is hot-forming magnetic powder coated in current-carrying coil 2.
F. As demonstrated in FIG. 15, hot forming body 4 formed by hot-forming magnetic powder changes into another derivative shape. The difference in shape with hot forming body 4 in FIG. 11 is hot-forming magnetic powder coated in current-carrying coil 2.

To sum up, aforementioned rod shape core rod 1, the following are the combination variation of T shape core rod 1A and hot forming body 4:
A. As demonstrated from FIG. 16 to 19, there is T shape rod space 41A in the hot forming body 4 in this group product, which combines T shape core rod 1A.
B. As demonstrated from FIG. 20 to 21, there are combinations with different rod 1 and T shape core rods 1A in hot forming body 4 of this group product.
C. As demonstrated from FIG. 22 to 25, there are combinations with different rod shape core rod 1 and T shape core rod 1A single bodies and T shape core rod 1A combination in hot forming body 4 of this group product, and an air gap A is formed between two core rods.

The above description is the magnetic component of hot forming body 4 which combines with single rod space or different core rods in the invention. As demonstrated in FIG. 26, during the implementation of hot forming body 4 in this invention, multiple rod shape rod spaces 41 or T shape rod spaces can be generated in single integrated hot forming body 4A, which performs the same or different rod space designs. Each rod space can also be combined with core rod and works with current-carrying coil and a pair of lead pads to produce integrated hot/cold forming assembling magnetic component. Hence, this invention includes multiple different core rod combination ways.

### BRIEF DESCRIPTION OF THE SEVERAL VIEWS OF THE DRAWINGS

FIG. 1 is the magnetic component three-dimensional figure of rod shape core rod combination in this invention.

FIG. 2 is the magnetic component decomposition three-dimensional figure of rod shape core rod combination in this invention.

FIG. 3 is the magnetic component cross section view of rod shape core rod combination in this invention.

FIG. 4 is the magnetic component three-dimensional figure of T shape core rod combination in this invention.

FIG. 5 is the magnetic component decomposition three-dimensional figure of T shape core rod combination in this invention.

FIG. 6 is the magnetic component cross section view of T shape core rod combination in this invention.

FIGS. 7 to 9 are the decomposition three-dimensional figures of different T shape core rods which are composed of multiple components in this invention.

FIGS. 10 to 15 is the cross section view of every kind of hot forming body in this invention.

FIGS. 16 to 25 is the cross section view of every product which is combined in this invention.

FIG. 26 is the three-dimensional figure of hot forming body with multiple rod and T shape rod spaces in this invention, and magnetic component combined with multiple rod and T shape core rods.

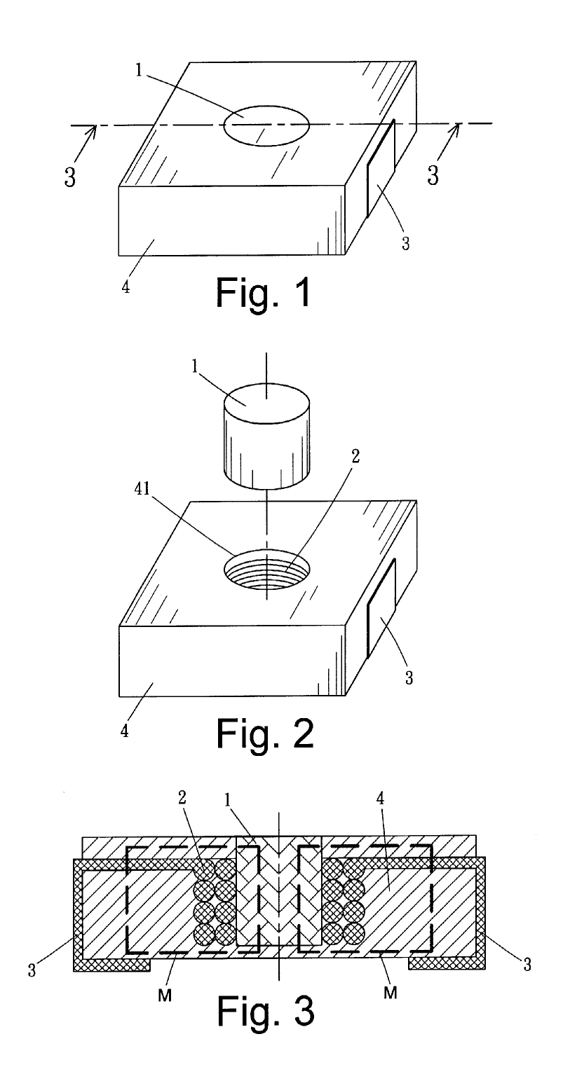

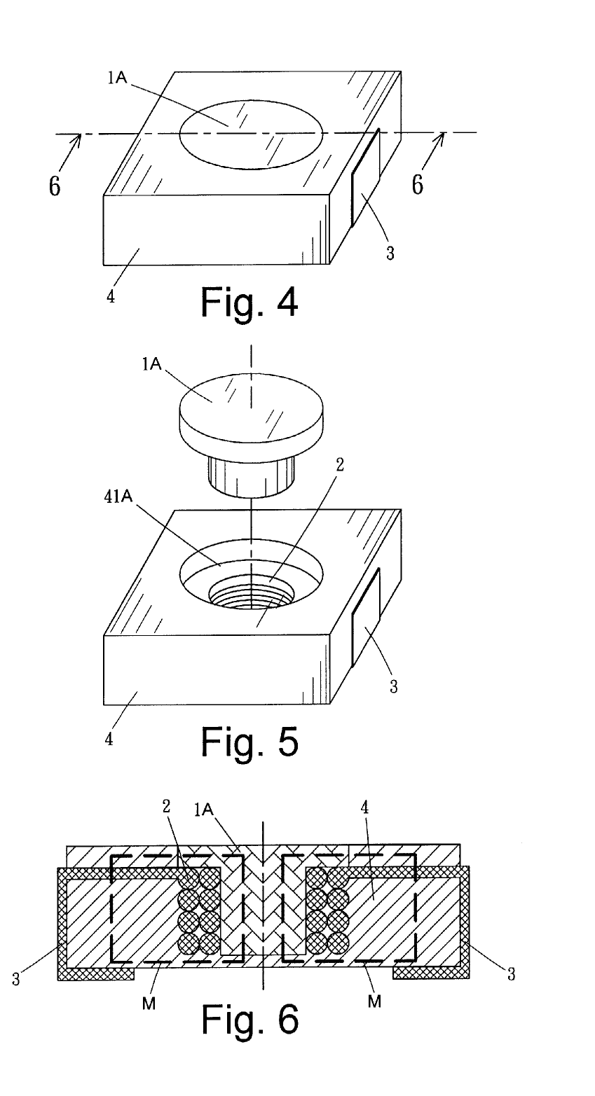

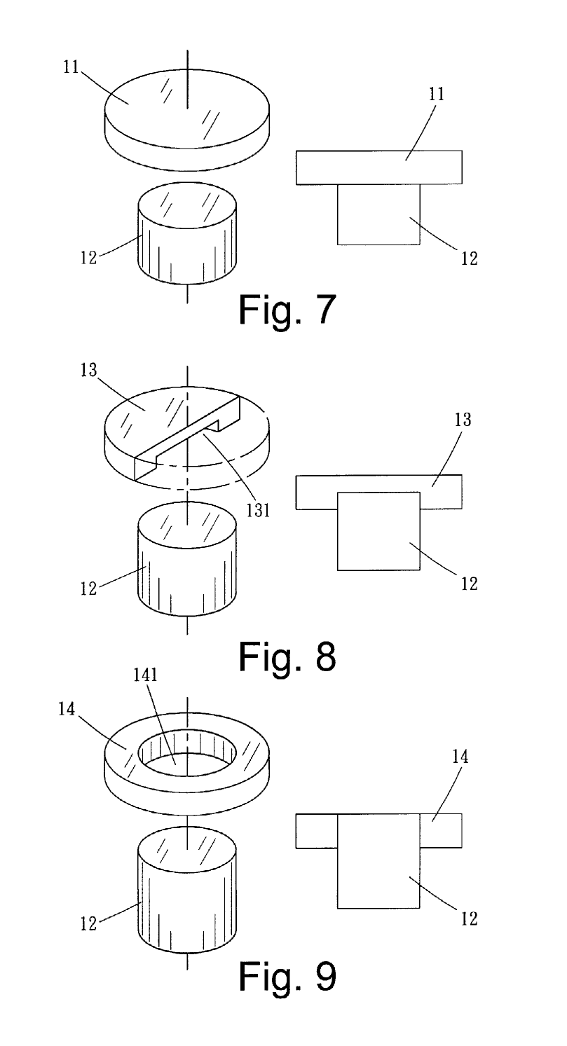

### DESCRIPTION OF PARTS

Rod shape core rod 1
T shape core rod 1A
Disk shape core rod 11
Rod shape core rod 12
Groove disk shape core rod 13
Groove 131
Perforated disk shape core rod 14
Hole 141
Current-carrying coil 2
Lead pad 3
Hot forming body 4
Integrated hot forming body 4A
Rod shape rod space 41
T shape rod space 41A
Air gap A
Magnetic field M

1. A hot/cold assembling magnetic component comprising
a rod shape core rod 1 is composed of magnetic powder and produced by cold forming technology, it is loaded in rod shape rod space 41 of hot forming body 4, there are also variations in rod shape core rod 1, which are rod shape core rod 1 including single body, T shape core rod 1A and rod shape core rod 1 or T shape core rod 1A which is composed of multiple core rod components;
a current-carrying coil 2, it is the coil generated by insulated copper wire;
a pair of lead pads 3 are mainly composed of conductive copper sheets, one end of each lead pad is connected to one of the ends in current-carrying coil 2, and one end extends out of hot forming body 4 as the current input and output electrode;
a hot forming body 4 is composed of hot forming magnetic powder and generated by hot forming technology, magnetic powder coats current-carrying coil 2 and part of lead pad 3, and rod shape rod space 41 for rod shape core rod 2 is reserved;
rod shape rod space 41 can also be T shape rod space 41A;
above rod shape core rod 1 or T shape core rod 1A is added with glue and loaded in rod shape rod space 41 of hot forming body 4, in order to assemble hot/cold forming assembling magnetic component.

2. The hot/cold assembling magnetic component of claim 1, the rod shape core rod 1 can be divided into independent single body or combination of multiple components
A. independent single body: the material is totally the same, which is generated by single magnetic powder through cold forming technology, including single body rod shape core rod 1 and single body T shape core rod 1A, the two kinds of single bodies can combine with other or the same single body;
B. multiple components: final T shape core rod 1A is assembled by using multiple components; the same or different magnetic powder can be used in each component, which is generated by cold forming technology, the advantage is to combine different magnetic powders according to magnetic component requirement, which include
1. combine disk shape core rod 11 with rod shape core rod to form T shape core rod 1A;
2. combine groove disk shape core rod 13 of groove 131 with rod shape core rod 12 to form T shape core rod 1A;
3. combine perforated disk shape core rod 14 of hole 141 with rod shape core rod 12 to form T shape core rod 1A, as for rod shape core rod 12, the length can be adjusted to be out of the surface of perforated disk shape core rod 14 according to requirements.

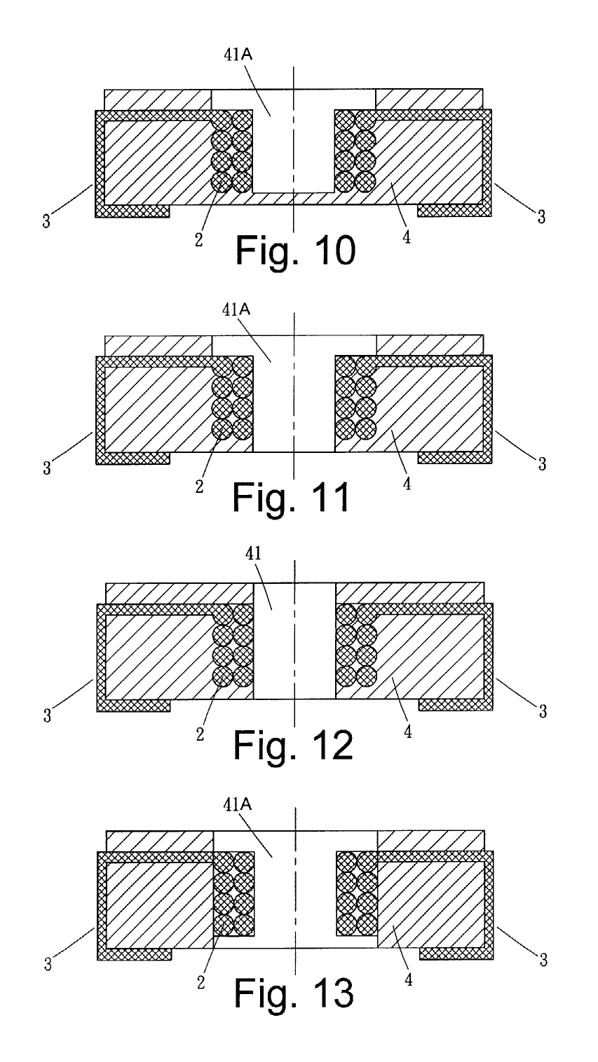

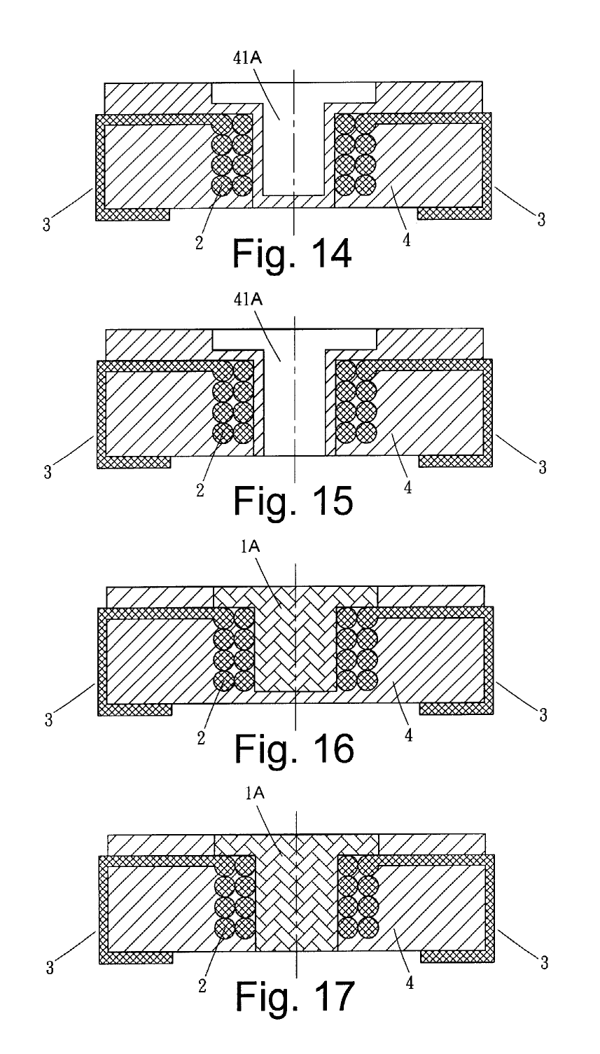

3. The hot/cold assembling magnetic component of claim 1, the hot forming body 4 includes
A. bowl structure is formed to coat the exterior and bottom of current-carrying coil 2, and current-carrying coil 2 interior, top, and coil center are exposed to form T shape rod space 41A right above the center of current-carrying coil 2;
B. changes into bowl structure to coat the external side and bottom of current-carrying coil, and interior and top of current-carrying coil are exposed, besides, the right below side of current-carrying coil 2 center is not coated, and T shape rod space 41A is formed;
C. changes into bowl structure to coat the exterior and bottom of current-carrying coil 2, and interior of current-carrying coil 2 is exposed, besides, the right above and right below side of current-carrying coil 2 center are not coated, and rod shape rod space 41 is formed;
D. changes into bowl structure to coat the exterior of current-carrying coil 2 only, and interior, top and bottom current-carrying coil 2 are exposed to form “I” shape rod space which is composed of two T shape rod spaces.
E. changes into derivative shape, the difference with hot forming body 4 shape in FIG. 10 is that current-carrying coil 2 interior coats hot-forming magnetic powder;
F. changes into another derivative shape, the difference with hot forming body 4 shape in FIG. 11 is that current-carrying coil 2 interior coats hot-forming magnetic powder;

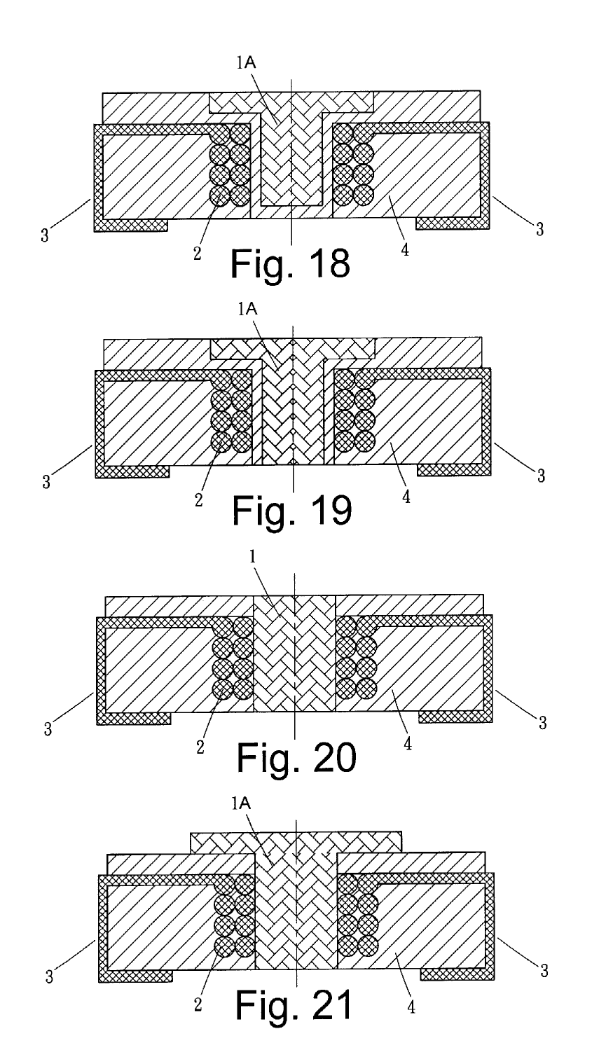

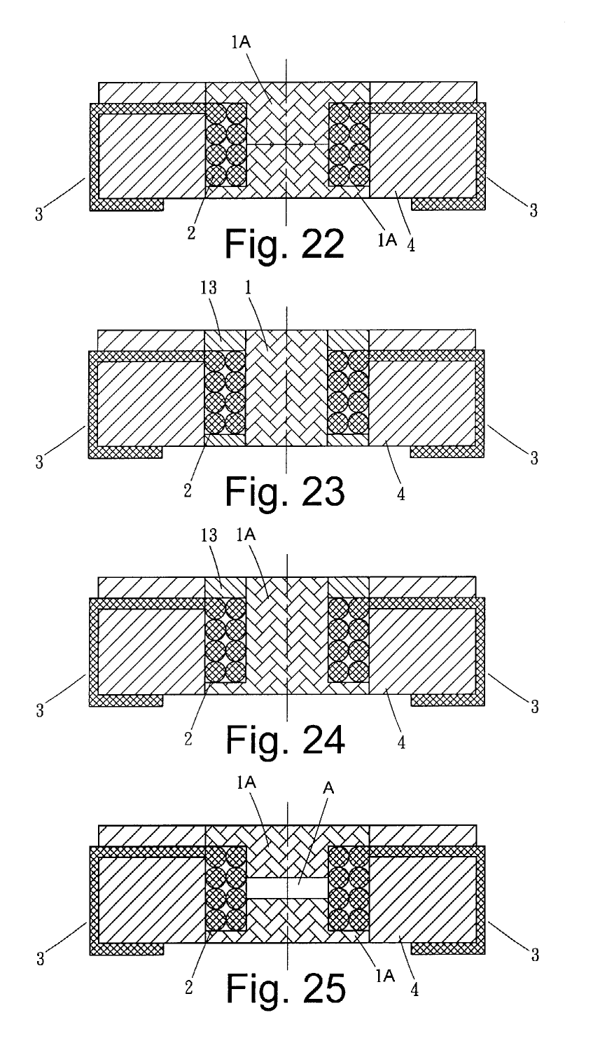

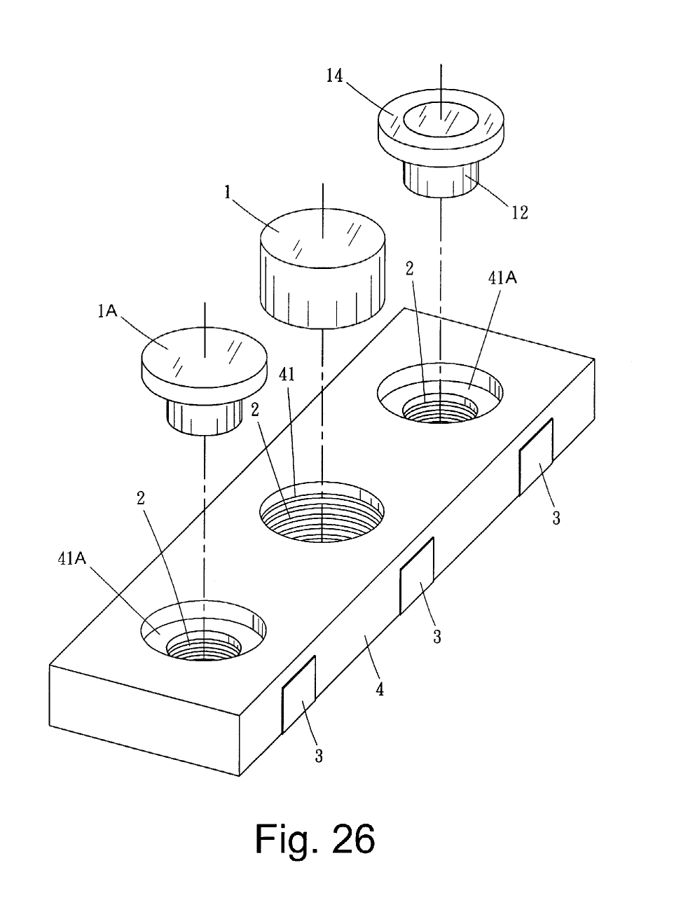

4. The hot/cold assembling magnetic component of claim 3, the assembling way of rod shape core rod 1, T shape core rod 1A, disk shape core rod 11, rod shape core rod 12 and groove disk shape core rod 13 with current-carrying coil 2 and hot forming body 4 includes the style demonstrated from FIG. 16 to 20.

5. The hot/cold assembling magnetic component of claim 4, the combination of rod shape core rod 1, T shape core rod 1A and hot forming body forms an air gap A between two core rods.

6. The hot/cold assembling magnetic component of claim 1, the hot forming body 4 generates single integrated hot forming body including multiple rod shape rod spaces 41 or T shape rod spaces, which makes each rod space combines with core rod and works with current-carrying coil and a pair of lead pads to generate integrated hot/cold forming assembling magnetic component.
